(19) United States
(12) Patent Application Publication
(10) Pub. No.: US 2020/0225728 A1
(43) Pub. Date: Jul. 16, 2020

(54) SYSTEM AND APPARATUS FOR IMPROVED DISPLAY PROCESSING BLINKING OPERATION

(71) Applicant: QUALCOMM Incorporated, San Diego, CA (US)

(72) Inventors: Dileep MARCHYA, Hyderabad (IN); Samson KIM, Richmond Hill (CA)

(21) Appl. No.: 16/248,008

(22) Filed: Jan. 15, 2019

(51) Int. Cl. G06F 1/3234; G06F 3/0481; H04N 19/423

(52) U.S. Cl. CPC G06F 1/3259; H04N 19/423; G06F 3/04812; G06F 1/3265

(57) ABSTRACT

A method, an apparatus, and a computer-readable medium for displaying a blinking cursor are provided in a power-efficient manner. Various hardware and protocol command enhancements are provided allowing a visible cursor frame region and an invisible cursor frame region are sequentially displayed creating the blinking cursor effect. Further support is provided for compressed frames, for example, frames compressed with the VESA Display Stream Compression (DSC) standard.

The present Application for Patent is related to U.S. patent application Ser. No. 16/009,038 filed on Jun. 14, 2018 entitled “DISPLAY PROCESSING BLINKING OPERATION,” and assigned to the assignee hereof and hereby expressly incorporated by reference herein.

### FIELD

The present disclosure relates generally relates to display processing for blinking content.

### BACKGROUND

Computing devices often utilize a graphics processing unit (GPU) to accelerate the rendering of graphical data for display. Such computing devices may include, for example, computer workstations, mobile phones such as so-called smartphones, embedded systems, personal computers, tablet computers, and video game consoles. GPUs execute a graphics processing pipeline that includes a plurality of processing stages that operate together to execute graphics processing commands/instructions and output a frame. A central processing unit (CPU) may control the operation of the GPU by issuing one or more graphics processing commands/instructions to the GPU. Modern day CPUs are typically capable of concurrently executing multiple applications, each of which may need to utilize the GPU during execution. A device that provides content for visual presentation on a display generally includes a graphics processing unit (GPU).

A GPU renders a frame for display. This rendered frame may be processed by a display processing unit prior to being displayed. For example, the display processing unit may be configured to perform processing on one or more frames that were rendered for display by the GPU and subsequently output the processed frame to a display. The pipeline that includes the CPU, GPU, and display processing unit (DPU) may be referred to as a display processing pipeline.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In one example embodiment an apparatus for displaying content is discussed. The apparatus may include a panel memory. The apparatus may include a first auxiliary buffer. The apparatus may include a host processor, the host processor may be configured to store a frame for display in the panel memory, wherein the frame includes a first element at a first display location in a first visibility state, and store a content representative of the first element in a second visibility state in the first auxiliary buffer and associated display coordinates indicative of the first display location. The apparatus may include a display processor. The display processor may be configured to display the frame for display, responsive to a first period elapsing, superpose the content representative of the first element in the second visibility state at the first display location, and responsive to a second period elapsing, terminate superposing of the content representative of the first element in the second visibility state. The frame for display may be stored compressed in the panel memory, and the content representative of the first element in the second visibility state is stored uncompressed in the first auxiliary buffer. The frame for display may be stored compressed in the panel memory, and the content representative of the first element in the second visibility state includes a complete compressed slice of the frame. The apparatus may include a second auxiliary buffer. The host processor may be further configured to store a content representative of a second element in a second visibility state in the second auxiliary buffer and associated display coordinates indicative of a second display location, wherein the frame includes the second element at the second display location in a first visibility state. The display processor may be further configured to responsive to a third period elapsing, superpose the content representative of the second element in the second visibility state at the second display location, and responsive to a fourth period elapsing, terminating superpose of the content representative of the second element in the second visibility state. The host processor may be further configured to trigger a power-saving mode. The host processor may be further configured to wake from the power-saving mode responsive to user input terminating a blink cycle. The first visibility state of the first element may be visible, and the second visibility state of the first element may be invisible. The host processor may be further configured to determine the first and second periods to each be one or more vertical sync (VSync) units in length.

In another example embodiment a method for displaying content is discussed. The method may include storing, by a host processor, a frame for display in a panel memory, wherein the frame includes a first element at a first display location in a first visibility state. The method may include storing, by the host processor, a content representative of the first element in a second visibility state in a first auxiliary buffer and associated display coordinates indicative of the first display location. The method may include displaying, by a display processor, the frame for display. The method may include superposing, by the display processor responsive to a first period elapsing, the content representative of the first element in the second visibility state at the first display location. The method may include responsive to a second period elapsing, the display processor terminating superposing of the content representative of the first element in the second visibility state. The frame for display may be stored compressed in the panel memory, and the content representative of the first element in the second visibility state may be stored uncompressed in the first auxiliary buffer. The frame for display may be stored compressed in the panel memory, and the content representative of the first element in the second visibility state includes a complete compressed slice of the frame. The method may include storing, by the host processor, a content representative of a second element in a second visibility state in a second auxiliary buffer and associated display coordinates indicative of a second display location, wherein the frame includes the second element at the second display location in a first visibility state, superposing, by the display processor responsive to a third period elapsing, the content representative of the second element in the second visibility state at the second display location; and responsive to a fourth period elapsing, the display processor terminating superposing of the content representative of the second element in the second visibility state. The method may include triggering a power-saving mode by the host processor. The method may include responsive to user input terminating a blink cycle, waking the host processor from the power-saving mode. The first visibility state of the first element may be visible, and the second visibility state of the first element may be invisible. The method may include determining the first and second periods to each be one or more vertical sync (VSync) units in length.

In another example embodiment an apparatus for displaying content is discussed. The apparatus may include a means for storing a frame for display. The apparatus may include a means for storing content of a first element. The apparatus may include a means for host processing configured to store a frame for display in the means for storing a frame for display, wherein the frame includes a first element at a first display location in a first visibility state, and store a content representative of the first element in a second visibility state in the means for storing content of a first element and associated display coordinates indicative of the first display location. The apparatus may include a means for display processing configured to display the frame for display, responsive to a first period elapsing, superpose the content representative of the first element in the second visibility state at the first display location, and responsive to a second period elapsing, terminate superposing of the content representative of the first element in the second visibility state. The frame for display may be stored compressed in the means for storing a frame for display, and the content representative of the first element in the second visibility state is stored uncompressed in the means for storing content of a first element. The frame for display may be stored compressed in the means for storing a frame for display, and the content representative of the first element in the second visibility state includes a complete compressed slice of the frame. The apparatus may include a means for storing content of a second element, wherein the means for host processing is further configured to,

store a content representative of a second element in a second visibility state in the means for storing content of a second element and associated display coordinates indicative of a second display location, wherein the frame includes the second element at the second display location in a first visibility state. The means for display processing may be further configured to, responsive to a third period elapsing, superpose the content representative of the second element in the second visibility state at the second display location, and responsive to a fourth period elapsing, terminating superpose of the content representative of the second element in the second visibility state. The means for host processing may be further configured to trigger a power-saving mode. The means for host processing may be further configured to wake from the power-saving mode responsive to user input terminating a blink cycle. The first visibility state of the first element may be visible, and the second visibility state of the first element is invisible. The means for host processing may be further configured to determine the first and second periods to each be one or more vertical sync (VSync) units in length.

In another example embodiment a non-transitory computer-readable storage medium having stored thereon instructions that, when executed, cause a processor to execute a method for displaying content is discussed. The method may include storing, by a host processor, a frame for display in a panel memory, wherein the frame includes a first element at a first display location in a first visibility state. The method may include storing, by the host processor, a content representative of the first element in a second visibility state in a first auxiliary buffer and associated display coordinates indicative of the first display location. The method may include displaying, by a display processor, the frame for display. The method may include superposing, by the display processor responsive to a first period elapsing, the content representative of the first element in the second visibility state at the first display location. The method may include responsive to a second period elapsing, the display processor terminating superposing of the content representative of the first element in the second visibility state. The frame for display may be stored compressed in the panel memory, and the content representative of the first element in the second visibility state may be stored uncompressed in the first auxiliary buffer. The frame for display may be stored compressed in the panel memory, and the content representative of the first element in the second visibility state includes a complete compressed slice of the frame. The method may include storing, by the host processor, a content representative of a second element in a second visibility state in a second auxiliary buffer and associated display coordinates indicative of a second display location, wherein the frame includes the second element at the second display location in a first visibility state, superposing, by the display processor responsive to a third period elapsing, the content representative of the second element in the second visibility state at the second display location; and responsive to a fourth period elapsing, the display processor terminating superposing of the content representative of the second element in the second visibility state. The method may include triggering a power-saving mode by the host processor. The method may include responsive to user input terminating a blink cycle, waking the host processor from the power-saving mode. The first visibility state of the first element may be visible, and the second visibility state of the first element may be invisible. The method may include determining the first and second periods to each be one or more vertical sync (VSync) units in length.

In an aspect of the disclosure, a method, a computer-readable medium, and an apparatus are provided. The apparatus may include a first processing unit and a second processing unit. The first processing unit may be configured to cause the second processing unit to store a frame for display in a first memory region. The first processing unit may be configured to cause the second processing unit to store first cursor content in a second memory region. The first cursor content may be representative of a visible state of a cursor. The first processing unit may be configured to cause the second processing unit to store second cursor content in a third memory region. The second cursor content may be representative of a non-visible state of the cursor.

In an aspect of the disclosure, a method, a computer-readable medium, and an apparatus are provided. The apparatus may include a first processing unit. The first processing unit may be configured to store a frame for display in a first memory region of a plurality of memory regions. The first memory region may be configured to be accessible to the first processing unit. The first processing unit may be configured to store first cursor content in a second memory region. The first cursor content may be indicative of a visible state of a cursor. The second memory region may be configured to be accessible to the first processing unit. The first processing unit may be configured to store second cursor content in a third memory region. The second cursor content may be indicative of a non-visible state of the cursor. The third memory region may be configured to be accessible to the first processing unit.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1A is a block diagram that illustrates an example content generation and coding system in accordance with the techniques of this disclosure.

FIG. 1B is a block diagram that illustrates an example configuration between a component of the device depicted in FIG. 1A and a display.

FIGS. 2A and 2B illustrate an example flow diagram in accordance with the techniques described herein.

FIG. 3 illustrates an example of content for use in performing a content blink operation in accordance with the techniques described herein.

FIG. 4 illustrates an example of a content blink operation in accordance with the techniques described herein.

FIG. 5 illustrates an example flowchart of an example method in accordance with one or more techniques of this disclosure.

FIG. 6 illustrates an example flowchart of an example method in accordance with one or more techniques of this disclosure.

FIG. 7A illustrates another example of a content blink operation in accordance with the techniques described herein.

FIG. 7B illustrates another example of a content blink operation in accordance with the techniques described herein.

FIG. 7C illustrates another example of a content blink operation in accordance with the techniques described herein.

### DETAILED DESCRIPTION

A blinking text cursor is conventionally used to indicate an application is awaiting user input in many user interfaces. A blinking text cursor can be expensive for a host processor to render and display, as the frame buffer must be composed and transferred for each blink cycle (on and off) of the cursor. A first frame is displayed depicting a visible cursor. A second frame is subsequently displayed depicting an invisible cursor. A previous approach utilized a display panel ping-pong buffer allowing the host processor to transfer a visible and an invisible cursor frame display region, and instructions for a display panel controller to swap the two on the display at a specified frequency. This allows the host processor to remain in power saving mode for the duration of cursor blinking.

Further improvements are presented. First, reduce required additional memory to one buffer size by only storing one cursor state to be super-imposed or superposed on the frame buffer displaying a second cursor state. This eliminates the need for the second buffer of the prior ping-pong buffer. Second, VESA Display Stream Compression (“DSC”) content is supported by uncompressing the cursor region into an auxiliary buffer, then super-impose or superpose as above to produce the blinking cursor effect. Third, DSC content is further supported with a compressed auxiliary buffer storing compressed frame slices.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems on a chip (SoC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application (i.e., software) being configured to perform one or more functions. In such examples, it is understood that the application may be stored on a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to graphical content or display content. In some examples, as used herein, the term “graphical content” may refer to a content generated by a processing unit configured to perform graphics processing. For example, the term “graphical content” may refer to a content generated by one or more processes of a graphics processing pipeline. In some examples, as used herein, the term “graphical content” may refer to a content generated by a graphics processing unit. In some examples, as used herein, the term “display content” may refer to content generated by a processing unit configured to perform displaying processing. In some examples, as used herein, the term “display content” may refer to a content generated by a display processing unit. In accordance with the techniques described herein, display content may be destined for display in some examples, and may not be destined for display in other examples. Otherwise described, display content may be generated for display in some examples, and display content may be generated that is not for display in other examples. Graphical content may be processed to become display content. For example, a graphics processing unit may output graphical content, such as a frame, to a buffer. A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling (e.g., upscaling or downscaling) on a frame. In some examples, a frame may refer to a layer. In other examples, a frame may refer to two or more layers that have already been blended together to form the frame (i.e., the frame includes two or more layers, and the frame that includes two or more layers may subsequently be blended).

As referenced herein, a first component (e.g., a GPU) may provide content, such as a frame, to a second component (e.g., a display processing unit). In some examples, the first component may provide content to the second component by storing the content in a memory accessible to the second component. In such examples, the second component may be configured to read the content stored in the memory by the first component. In other examples, the first component may provide content to the second component without any intermediary components (e.g., without memory or another component). In such examples, the first component may be described as providing content directly to the second component. For example, the first component may output the content to the second component, and the second component may be configured to store the content received from the first component in a memory, such as a buffer.

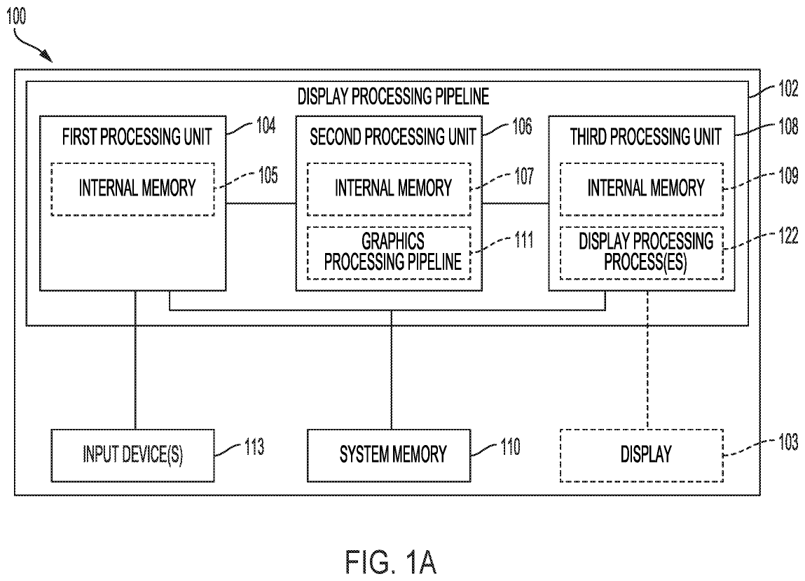

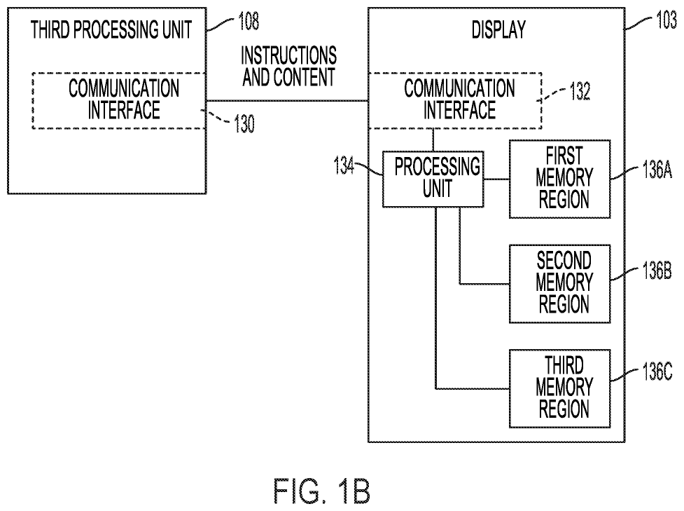

FIG. 1A is a block diagram that illustrates an example device 100 configured to perform one or more techniques of this disclosure. The device 100 includes display processing pipeline 102 configured to perform one or more technique of this disclosure. In accordance with the techniques described herein, the display processing pipeline 102 may be configured to generate content destined for display. The display processing pipeline 102 may be communicatively coupled to a display 103. In the example of FIG. 1A, the display 103 is a display of the device 100. However, in other examples, the display 103 may be a display external to the device 100. Reference to display 103 may refer to a display of the device or a display external to the device.

In examples where the display 103 is not external to the device 100, the a component of the device may be configured to transmit or otherwise provide commands and/or content to the display 103 for presentment thereon. In examples where the display 103 is external to the device 100, the device 100 may be configured to transmit or otherwise provide commands and/or content to the display 103 for presentment thereon. As used herein, “commands” and “instructions” may be used interchangeably. In some examples, the display 103 of the device 100 may represent a display of a user equipment, such as but not limited to a mobile phone, tablet, display panel, or the like. In some examples, the display 103 may include one or more of: a liquid crystal display (LCD), a plasma display, an organic light emitting diode (OLED) display, a projection display device, an augmented reality display device, a virtual reality display device, a head-mounted display, or any other type of display.

The display processing pipeline 102 may include one or more components (or circuits) configured to perform one or more techniques of this disclosure. As used herein, reference to the display processing pipeline being configured to perform any function, technique, or the like refers to one or more components of the display processing pipeline being configured to form such function, technique, or the like.

In the example of FIG. 1A, the display processing pipeline 102 includes a first processing unit 104, a second processing unit 106, and a third processing unit 108. In some examples, the first processing unit 104 may be configured to execute one or more applications, the second processing unit 106 may be configured to perform graphics processing, and the third processing unit 108 may be configured to perform display processing. In such examples, the first processing unit 104 may be a central processing unit (CPU), the second processing unit 106 may be a graphics processing unit (GPU) or a general purpose GPU (GPGPU), and the third processing unit 108 may be a display processing unit, which may also be referred to as a display processor. In other examples, the first processing unit 104, the second processing unit 106, and the third processing unit 108 may each be any processing unit configured to perform one or more feature described with respect to each processing unit.

The first processing unit may include an internal memory 105. The second processing unit 106 may include an internal memory 107. The third processing unit 108 may include an internal memory 109. One or more of the processing units 104, 106, and 108 of the display processing pipeline 102 may be communicatively coupled to an external memory 110. The external memory 110 external to the one or more of the processing units 104, 106, and 108 of the display processing pipeline 102 may, in some examples, be a system memory. The system memory may be a system memory of the device 100 that is accessible by one or more components of the device 100. For example, the first processing unit 104 may be configured to read from and/or write to the external memory 110. The second processing unit 106 may be configured to read from and/or write to the external memory 110. The third processing unit 108 may be configured to read from and/or write to the external memory 110. The first processing unit 104, the second processing unit 106, and the third processing unit 108 may be communicatively coupled to the external memory 110 over a bus. In some examples, the one or more components of the display processing pipeline 102 may be communicatively coupled to each other over the bus or a different connection. In other examples, the system memory may be a memory external to the device 100.

The internal memory 105, the internal memory 107, the internal memory 109, and/or the external memory 110 may include one or more volatile or non-volatile memories or storage devices. In some examples, the internal memory 105, the internal memory 107, the internal memory 109, and/or the external memory 110 may include random access memory (RAM), static RAM (SRAM), dynamic RAM (DRAM), erasable programmable ROM (EPROM), electrically erasable programmable ROM (EEPROM), Flash memory, a magnetic data media or an optical storage media, or any other type of memory.

The internal memory 105, the internal memory 107, the internal memory 109, and/or the external memory 110 may be a non-transitory storage medium according to some examples. The term “non-transitory” may indicate that the storage medium is not embodied in a carrier wave or a propagated signal. However, the term “non-transitory” should not be interpreted to mean that the internal memory 105, the internal memory 107, the internal memory 109, and/or the external memory 110 is non-movable or that its contents are static. As one example, the external memory 110 may be removed from the device 100 and moved to another device. As another example, the external memory 110 may not be removable from the device 100.

In some examples, the first processing unit 104 may be configured to perform any technique described herein with respect to the second processing unit 106. In such examples, the display processing pipeline 102 may only include the first processing unit 104 and the third processing unit 108. Alternatively, the display processing pipeline 102 may still include the second processing unit 106, but one or more of the techniques described herein with respect to the second processing unit 106 may instead be performed by the first processing unit 104.

In some examples, the first processing unit 104 may be configured to perform any technique described herein with respect to the third processing unit 108. In such examples, the display processing pipeline 102 may only include the first processing unit 104 and the second processing unit 106. Alternatively, the display processing pipeline 102 may still include the third processing unit 108, but one or more of the techniques described herein with respect to the third processing unit 108 may instead be performed by the first processing unit 104.

In some examples, the second processing unit 106 may be configured to perform any technique described herein with respect to the third processing unit 108. In such examples, the display processing pipeline 102 may only include the first processing unit 104 and the second processing unit 106. Alternatively, the display processing pipeline 102 may still include the third processing unit 108, but one or more of the techniques described herein with respect to the third processing unit 108 may instead be performed by the second processing unit 106.

The first processing unit 104 may be configured to perform any process described herein with respect to the first processing unit 104.

The second processing unit 106 may be configured to perform graphics processing in accordance with the techniques described herein, such as in a graphics processing pipeline 111. Otherwise described, the second processing unit 106 may be configured to perform any process described herein with respect to the second processing unit 106.

The third processing unit 108 may be configured to perform one or more display processing processes 122 in accordance with the techniques described herein. The one or more display processing processes 122 may include a content blinking operation (which may also be referred to as a blinking operation) described herein. Content that blinks may be any content, such as a cursor. Blinking content may be indicative of a user interaction location. For example, the third processing unit 108 may be configured to perform one or more display processing techniques on one or more frames generated by the second processing unit 106 before and/or during presentment by the display 103. Otherwise described, the third processing unit 108 may be configured to perform display processing. In some examples, the one or more display processing processes 122 may include one or more of a rotation operation, a blending operation, a scaling operation, a blinking operation, any display processing process/operation, or any process/operation described herein with respect to the third processing unit 108.

In some examples, the one or more display processing processes 122 include any process/operation described herein with respect to the third processing unit 108. The display 103 may be configured to display content that was generated using the display processing pipeline 102. For example, the second processing unit 106 may generate graphical content based on commands/instructions received from the first processing unit 104. The graphical content may include one or more layers. Each of these layers may constitute a frame of graphical content. The third processing unit 108 may be configured to perform composition on graphical content rendered by the second processing unit 106 to generate display content. Display content my constitute a frame for display. The frame for display may include two or more layers/frames that were blended together by the third processing unit 108.

The device 100 may include or be connected to one or more input devices 113. In some examples, the one or more input devices 113 includes one or more of: a touch screen, a mouse, a peripheral device, an audio input device (e.g., a microphone or any other visual input device), a visual input device (e.g., a camera, an eye tracker, or any other visual input device), any user input device, or any input device configured to receive an input from a user. In some examples, the display 103 may be a touch screen display; and, in such examples, the display 103 constitutes an example input device 113. In the example of FIG. 1A, the display 103 may be a touch screen display and is communicatively coupled to the display processing pipeline 102, such that input received at the display 103 can be communicated to one or more components of the display processing pipeline 102. The touch screen display detects when contact is made with the touch screen display, and may be configured to determine a touch point. The touch screen display may be configured to convert the touch point into information. For example, the touch screen display may receive a touch point as an input and provide, as an output, touch point information that is indicative of contact with the touch screen display received. The touch screen display may be configured to provide touch point information to the first processing unit 104. It is understood that the output of an input device may constitute an input to a component receiving the output. In some examples, the touch point information may be any information output by the touch screen display representative of contact with the touch screen, such as data, a voltage signal, any signal, or any other information. The touch screen display 103 may be integrated with the device 100 so that the touch screen display may be configured to detect contact with the touch screen display and not sense contact with other portions of the device 100. For example, the touch screen display 103 may be configured to detect one or more touch points on the touch screen display, while contact with other portions and/or components near or otherwise around the device 100 are not detected by the touch screen display 103. The first processing unit 104 may be configured to determine touch point information based on information received from the touch screen display 103.

The display processing pipeline 102 may be configured to execute one or more applications. For example, the first processing unit 104 may be configured to execute one or more applications. The first processing unit 104 may be configured to cause the second processing unit 106 to generate content for the one or more applications being executed by the first processing unit 104. Otherwise described, execution of the one or more applications by the first processing unit 104 may cause the generation of graphical content by a graphics processing pipeline 111. For example, the first processing unit 104 may issue or otherwise provide instructions (e.g., draw instructions) to the second processing unit 106 that cause the second processing unit 106 to generate graphical content based on the instructions received from the first processing unit 104. The second processing unit 106 may be configured to generate one or more layers for each application of the one or more applications executed by the first processing unit 104. Each layer generated by the second processing unit 106 may be stored in a buffer. Otherwise described, the buffer may be configured to store one or more layers of graphical content rendered by the second processing unit 106. The buffer may reside in the internal memory 107 of the second processing unit 106 and/or the external memory 110 (which may be system memory of the device 100 in some examples). Each layer produced by the second processing unit 106 may constitute graphical content. The one or more layers may correspond to a single application or a plurality of applications. The second processing unit 106 may be configured to generate multiple layers of content, meaning that the first processing unit 104 may be configured to cause the second processing unit 106 to generate multiple layers of content. In some aspects, the display 103 may comprise internal memory. In some examples, the buffer may reside in the internal memory of the display 103. The buffer of the display 103 may be configured to store content for display, such as graphical content that was rendered by the second processing unit 106 and subsequently further processed by the third processing unit 108. For example, the third processing unit 108 may be configured to provide content to the display 103. The content may be content that has been processed by the third processing unit 108. The content that the third processing unit 108 processes may have been rendered by the second processing unit 106.

FIG. 1B is a block diagram that illustrates an example configuration between a component of the device depicted in FIG. 1A and a display. The third processing unit 108 and the display 103 may be configured to communicate with each other over a communication medium (e.g., a wired and/or wireless communication medium). For example, the third processing unit 108 may include a communication interface 130 (e.g., a bus interface) and the display 103 may include a communication interface 132 (e.g., a bus interface) that enables communication between each other. In some examples, the communication between the third processing unit 108 and the display 103 may be compliant with a communication standard, communication protocol, or the like. For example, the communication between the third processing unit 108 and the display 103 may be compliant with the Display Serial Interface (DSI) standard. In some examples, the third processing unit 108 may be configured to provide content (e.g., a frame for display, first content for a blinking operation, and second content for a blinking operation) and one or more instructions (e.g., an instruction that causes the display to perform a blinking operation described herein and an instruction that causes the display to stop performing the blinking operation) to the display 103. The display 103 may include a processing unit 134, which may be referred to as a display controller of the display 103. The processing unit 134 may be configured to cause content received from the third processing unit 108 to be displayed in accordance with the techniques described herein based on the one or more instructions received from the third processing unit 108.

The processing unit 134 may be configured to perform any process/operation described herein with respect to the display 103. For example, the processing unit 134 may be configured to receive content and one or more instructions from the third processing unit 108. Based on the content and the one or more instructions received from the third processing unit 108, the processing unit 134 may be configured to perform a blinking operation. The blinking operation enables the presentment of blinking content (e.g., a cursor) over a period of time. In some examples, upon initiation of the blinking operation, the third processing unit 108 may enter a first power mode, such as a low power mode. Therefore, during the blinking operation, the processing unit 134 may not receive any additional content or instructions from the third processing unit 108. To stop the blinking operation, the third processing unit 108 may be configured to enter a second power mode (e.g., a normal power mode) from the first power mode (e.g., a low power mode), such as in response to a trigger event, and provide one or more instructions to the processing unit 134 configured to stop the blinking operation.

Referring to FIG. 1B, a plurality of memory regions 136A-C accessible by the processing unit 134 are shown. The plurality of memory regions 136A-C may be configured to store content that the display 103 receives from the third processing unit 108. For example, one or more of the memory regions 136A-C may be configured to store (e.g., buffer) one or more frames received from the third processing unit 108.

The processing unit 134 may be configured to read content stored in one or more of the memory regions 136A-C that was received from the third processing unit 108 and drive the display 103 based on one or more instructions received from the third processing unit 108. As described below in more detail, the first memory region 136A may be used for storing a frame for display that includes a target region/location. The target region may be updated using content stored in the second memory region 136B and the third memory region 136C in an alternating fashion to provide blinking content at the target region in the frame. In this regard, the second and third memory regions 136B and 136C may be collectively referred to as a ping-pong buffer. In some examples, the target region may be referred to as a dirty region. The target region may have a size and shape.

In some examples, each respective memory region of the plurality of memory regions 136A-C may be a region in a single memory. In other examples, the first memory region 136A may be a region in a first memory, the second memory region 136B may be a region in a second memory, and the third memory region 136C may be a region within the second memory. In such examples, the first memory and the second memory may be physically distinct from each other. In other examples, the first memory region 136A may be a region in a first memory, the second memory region 136B may be a region in a second memory, and the third memory region 136C may be a region in a third memory. In such examples, the first memory, the second memory, and the third memory may be physically distinct from each other.

The first memory region 136A may have a first size, the second memory region 136B may have a second size, and the third memory region 136C may have a third size. The first size may be greater than the second size and the third size. In some examples, the second size and the third size may be the same size.

As described above, the memory regions 136A-C may be configured in many different configurations and the disclosure is not limited to the examples disclosed herein. As another example, the first memory region 136A may correspond to a frame buffer, and the second and third memory regions 136B and 136C together may correspond to a ping-pong buffer.

In some examples, the content stored in memory regions 136A-C may include a frame for display and blinking content (e.g., cursor content). The examples herein may be described with respect to cursor content/cursor blinking. However, it is understood that cursor content is just one example of content, and that the techniques described herein may be used to enable the blinking of any content (e.g., content different from cursor content). For example, the cursor content may be representative of a cursor that is to be displayed within the frame, such as at the target region. The cursor content may include first cursor content and second cursor content. The first cursor content may be representative of the cursor in a first state, such as a visible state. The second cursor content may be representative of the cursor in a second state, such as a non-visible state. The first state and the second state are different states.

In the example of FIG. 1B, the frame for display received from the third processing unit 108 may be stored/buffered in the first memory region 136A, the first cursor content may be stored/buffered in the second memory region 136B, and the second cursor content may be stored/buffered in the third memory region 136C.

The processing unit 134 may be configured to store the frame for display in the first memory region 136A. The processing unit 134 may be configured to store the first cursor content in the second memory region 136B. The first cursor content may be representative of a visible state of the cursor. The processing unit 134 may be configured to store the second cursor content in the third memory region 136C. The second cursor content may be representative of the non-visible state of the cursor.

The processing unit 134 may be configured to perform a content blink operation. As an example of a content blink operation, an example of a cursor blink operation is described herein. However, it is understood that the techniques described herein apply to any content blinking operation. In some examples, the third processing unit 108 may be configured to cause the processing unit 134 to perform the cursor blink operation. The third processing unit 108 may be configured to send instructions to the processing unit 134 to initiate the cursor blink operation. The processing unit 134 may be configured to initiate the cursor blink operation upon receipt of the instructions from the third processing unit 108. The cursor blink operation may be configured to update a portion of the frame for display, whereby the cursor may be in a visible or SHOW state or in a non-visible or HIDE state. The portion of the frame may be referred to as a target region, specified region, dirty region, or the like. The SHOW and HIDE states of the cursor may each be displayed within the frame for a period of time in an alternating fashion to provide the appearance of blinking content (in this example, a blinking cursor) at the portion of the frame. The SHOW/HIDE states of the cursor may repeat (e.g., cyclically repeat) until the processing unit 134 receives one or more instructions to stop the cursor blink operation. In some examples, the third processing unit 108 may be configured to send one or more instructions to the processing unit 134 to stop the cursor blink operation. In some examples, the third processing unit 108 may receive instructions from either the first processing unit 104 or the second processing unit 106 to send instructions to the processing unit 134 to stop the cursor blink operation. In some examples, the processing unit 134 may receive instructions from either of the first, second, and/or third processing units 104, 106, 108 to stop the cursor blink operation.

To perform the cursor blink operation, the third processing unit 108 may be configured to cause the processing unit 134 to store a frame for display in the first memory region 136A, to store first cursor content in the second memory region 136B, and to store second cursor content in the third memory region 136C. The processing unit 134 may be configured to copy the first cursor content from the second memory region 136B into a specified region in the first memory region 136A. The third processing unit 108 may be configured to define the location of the specified region within the first frame stored in the first memory region. The third processing unit provides the location of the specified region to the processing unit 134, such that the processing unit 134 knows the precise location as to where to copy the first and second cursor content into the first memory region 136A. The third processing unit 108 may be configured to define the period of time for which the first and second cursor content are to be displayed within the first frame. The third processing unit 108 may provide one or more instructions to the processing unit 134 that define the period of time and location that the first and second cursor content are to be displayed within the first frame.

Upon receipt of the instructions from the third processing unit 108, the processing unit 134 may be configured to copy the first cursor content into the specified region for the instructed period of time. The copying of the first cursor content may occur at a first time, where the first time may correspond to an end of a first period in a cycle. After the first cursor content has been displayed within the specified region for the instructed period of time, the processing unit 134 may be configured to copy the second cursor content from the third memory region 136C into the specified region in the first memory region 136A, thereby replacing the first cursor content with the second cursor content. The copying of the second cursor content may occur at a second time, where the second time may correspond to an end of a second period in the cycle. After the second cursor content has been displayed within the specified region for the instructed period of time, the processing unit 134 may be configured to copy the first cursor content into the specified region in the first memory region to replace the second cursor content within the specified region. The swapping out of the first and second cursor content may repeat to show the first and second cursor content in alternating fashion, which would be representative of a blinking cursor. The blinking operation may continue until the processing unit 134 receives one or more instructions/commands to stop.

In some examples, the first period and/or the second period may be defined by one or more vertical sync (VSync) units in length. A VSync unit may correspond to a period of time. The processing unit 134 may be configured to count VSync units to determine when the first period has elapsed and when the second period has elapsed. In some examples, the first period and the second period may be the same. In some examples, the first period and the second period may be different. The third processing unit 108 may be configured to send one or more instructions to the processing unit 134 which indicates the VSync units for each respective period (e.g., the number of VSync units corresponding to the first period and the number of VSync units corresponding to the second period). In other examples, the one or more instructions may include information indicative of the first period and information indicative of the second period. The respective information for each period may be information corresponding to time, VSync units, or the like. In some examples, a VSync unit may be dependent upon the refresh rate of the display and/or the display duration of the first and/or second cursor content. In some examples, the refresh rate of the display 103 may be 60 FPS (frames per second), which results in the display needing to be refreshed every 16.67 ms. In some examples, the blinking operation may be configured to display the first and/or second cursor content for a duration of 500 ms. As such, the VSync unit equals the display duration of the first and/or second cursor content divided by the refresh time of the display 103 (e.g., 500 ms/16.67 ms) which equals 30 VSync units. In some examples, the first and second cursor content can be displayed for the same number of VSync units. In other examples, the first and/or second cursor content can be displayed for different number of VSync units.

The processing unit 134 may be configured to receive instructions from the third processing unit 108 that identifies the specified region in the first memory region 136A. The instructions with regards to the VSync units and identification of the specified region from the third processing unit 108 enables the processing unit 134 to know the timing at which the first cursor content and second cursor content are to be displayed within the frame and the proper location of the specified region in which the first cursor content and second cursor content are to be copied within the first memory region. Such instructions assists the processing unit 134 to properly perform the blinking operation. For example, the first cursor content is copied to the proper location for the set duration, and is swapped out with the second cursor content, such that the second cursor content is subsequently copied to the proper location for the set duration. The second cursor content is then swapped out with the first cursor content and the cycle repeats until the blinking operation is terminated. The first cursor content and second cursor content swap for the set duration until the blinking operation is instructed to stop. In some examples, a trigger event could occur which may cause the blinking operation to be performed. For example, the trigger event that initiates the blinking operation could be a duration of inactivity, where the device 100 does not receive input from the input device 113 and/or the display 103. In some examples, a trigger event could occur which may cause the blinking operation to stop. For example, the trigger event could be receipt of an input from the input device 113 and/or the display while the blinking operation is being performed.

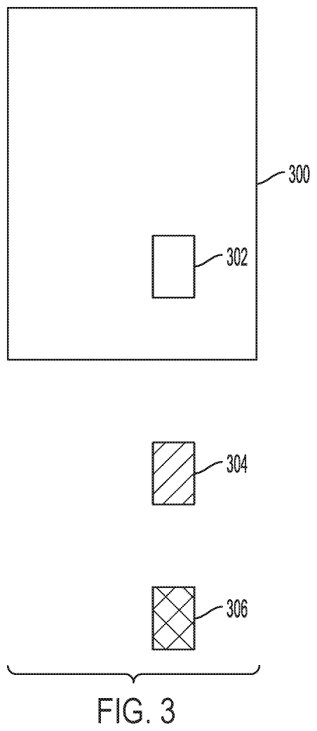

FIG. 3 illustrates an example of content for use in performing a content blink operation in accordance with the techniques described herein. The content blinking operation may be representative of a partial update feature, where only one or more regions of the display 103 are updated with new content (e.g. the first and second cursor content) relative to the previously displayed content. For example, as shown in FIG. 3, content (e.g. frame) 300 is shown and includes the specified region 302. The specified region 302 is the region of the content 300 that is updated with the first and second cursor content during the blinking operation. The first cursor content 304 may be copied into the specified region 302 in accordance with the process discussed above. The second cursor content 306 may be copied into the specified region 302. The first cursor content 304 may be displayed in the specified region 302 for a duration/period of time and is then swapped out with the second cursor content 306. The second cursor content 306 may be displayed in the specified region 302 for a duration/period of time, which may be the same or different than the duration/period of time that the first cursor content 304 was displayed. In some examples, the first cursor content 304 is representative of the cursor being in the visible state, while the second cursor content 306 is representative of the cursor being in a non-visible state. The specified region may be repeatedly updated (e.g., cyclically updated) with the first cursor content 304 and the second cursor content 306 such that a cursor blinks on the display even though content outside of the specified region 302 may not change and/or may not be updated.

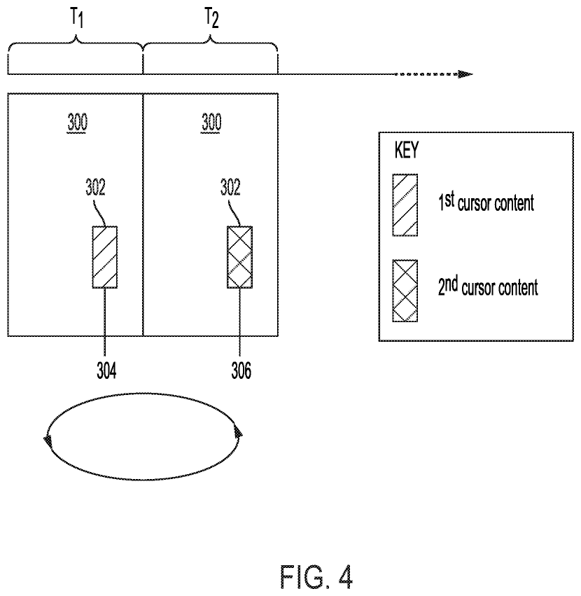

FIG. 4 illustrates an example of a content blink operation in accordance with the techniques described herein. Shown in FIG. 4 are two time periods: T1 and T2. During time period T1, the processing unit 134 may be configured to display the first cursor content 304 in the specified region 302 by copying the first cursor content from the second memory region 136B into the specified region. After time period T1, the first cursor content 304 is swapped out with the second cursor content 306. For example, the second cursor content 306 is copied from memory, by the processing unit 134, into the specified region 302 over the first cursor content 304. During time period T2, the processing unit 134 may be configured to display the second cursor content 306 in the specified region 302. As discussed above, the first cursor content 304 and the second cursor content 306 may be alternatingly copied into the specified region 302, by the processing unit 134, for one or more cycles. In some examples, the first cursor content 304 and the second cursor content 306 may be alternatingly copied into the specified region 302 for one or more cycles until the blinking operation is instructed to stop. In some examples, the first cursor content 304 may include a typical cursor, while the second cursor content 306 may include content that is similar to the first cursor content 304 with the exclusion of the typical cursor. In some examples, the content or frame 300 may include any content for display. In such examples, when the first cursor content 304 and the second cursor content 306 are alternatingly copied into the specified region 302, the content 300 may not be updated and/or may not change except for the content in the specified regions 302 that is being changed to provide the appearance of blinking content during the blinking operation.

In some examples, the display may be configured with one or more power saving features. One example of a power saving feature may include the blinking operation. The blinking operation may refer to a technique in which only partial regions of a display are updated with new content relative to the previous frame. For example, the blinking operation, discussed herein, may be a power saving feature that allows the device 100 to operate in a reduced power setting. For example, when the blinking operation is occurring, the processing unit 134 of the display 103 updates the specified region with the first and second cursor content, in accordance with instructions received from the third processing unit 108. The regions that differ may be referred to as dirty regions or regions requiring an update. In some examples, a region may refer to one or more pixels. In some examples, a region may refer to a tile. A tile may include a plurality of pixels. The third processing unit 108 provides instructions to the processing unit 134 of the display 103 with regards to the coordinates of the specified region (dirty region) that needs to be updated, as well as the time period. By only updating the specified or dirty regions, power savings is realized because it takes more power to update the entire screen of the display 103 instead of only the specified or dirty regions.

In addition, the instructions from the third processing unit 108 allow the processing unit 134 to operate independently during the blinking operation such that at least the third processing unit 108 of the display processing pipeline 102 may be arranged to enter into an inactive state. The inactive state may be a low power state due to the processing unit 134 being able to perform the blinking operation without constant instructions or involvement from the third processing unit 108. The third processing unit 108 may remain in the low power state throughout the duration of the blinking operation, which in turn reduces power consumption. The reduced power consumption can allow the device 100 to reduce battery consumption which extends battery life, reduces power costs, and increases hardware lifecycle. In addition, the third processing unit 108 being able to enter into an inactive state reduces the need for an entire frame to be rendered and composed each time the cursor switches states (e.g., from SHOW to HIDE, or from HIDE to SHOW) and refreshing the entire display to show the blinking cursor. A blinking cursor can be a significant contributor to Days of Usage (DoU), which is a metric tracked by some applications. The third processing unit 108 being able to enter into the inactive mode during the blinking operation may reduce the tracking of the DoU which could prolong the battery power and/or reduce power usage.

In some examples, one or more components of the device 100 and/or display processing pipeline 102 may be combined into a single component. For example, one or more components of the display processing pipeline 102 may be one or more components of a system on chip (SoC), in which case the display processing pipeline 102 may still include the first processing unit 104, the second processing unit 106, and the third processing unit 108; but as components of the SoC instead of physically separate components. In other examples, one or more components of the display processing pipeline 102 may be physically separate components that are not integrated into a single component. For example, the first processing unit 104, the second processing unit 106, and the third processing unit 108 may each be a physically separate component from each other. It is appreciated that a display processing pipeline may have different configurations. As such, the techniques described herein may improve any display processing pipeline and/or display, not just the specific examples described herein.

In some examples, one or more components of the display processing pipeline 102 may be integrated into a motherboard of the device 100. In some examples, one or more components of the display processing pipeline 102 may be may be present on a graphics card of the device 100, such as a graphics card that is installed in a port in a motherboard of the device 100 or a graphics card incorporated within a peripheral device configured to interoperate with the device 100.

The first processing unit 104, the second processing unit 106, and/or the third processing unit 108 may include one or more processors, such as one or more microprocessors, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. In examples where the techniques described herein are implemented partially in software, the software (instructions, code, or the like) may be stored in a suitable, non-transitory computer-readable storage medium accessible by the processing unit. The processing unit may execute the software in hardware using one or more processors to perform the techniques of this disclosure. For example, one or more components of the display processing pipeline 102 may be configured to execute software. The software executable by the first processing unit 104 may be stored in the internal memory 105 and/or the external memory 110. The software executable by the second processing unit 106 may be stored in the internal memory 107 and/or the external memory 110. The software executable by the third processing unit 108 may be stored in the internal memory 109 and/or the external memory 110.

As described herein, a device, such as the device 100, may refer to any device, apparatus, or system configured to perform one or more techniques described herein. For example, a device may be a server, a base station, user equipment, a client device, a station, an access point, a computer (e.g., a personal computer, a desktop computer, a laptop computer, a tablet computer, a computer workstation, or a mainframe computer), an end product, an apparatus, a phone, a smart phone, a server, a video game platform or console, a handheld device (e.g., a portable video game device or a personal digital assistant (PDA)), a wearable computing device (e.g., a smart watch, an augmented reality device, or a virtual reality device), a non-wearable device, an augmented reality device, a virtual reality device, a display (e.g., display device), a television, a television set-top box, an intermediate network device, a digital media player, a video streaming device, a content streaming device, an in-car computer, any mobile device, any device configured to generate content, or any device configured to perform one or more techniques described herein.

As described herein, devices, components, or the like may be described herein as being configured to communicate with each other. For example, one or more components of the display processing pipeline 102 may be configured to communicate with one or more other components of the device 100, such as the display 103, the external memory 110, and/or one or more other components of the device 100 (e.g., one or more input devices). One or more components of the display processing pipeline 102 may be configured to communicate with each other. For example, the first processing unit 104 may be communicatively coupled to the second processing unit 106 and/or the third processing unit 108. As another example, the second processing unit 106 may be communicatively coupled to the first processing unit 104 and/or the third processing unit 108. As another example, the third processing unit 108 may be communicatively coupled to the first processing unit 104 and/or the second processing unit 106.

As described herein, communication may include the communicating of information from a first component to a second component (or from a first device to a second device). The information may, in some examples, be carried in one or more messages. As an example, a first component in communication with a second component may be described as being communicatively coupled to or otherwise with the second component. For example, the first processing unit 104 and the second processing unit 106 may be communicatively coupled. In such an example, the first processing unit 104 may communicate information to the second processing unit 106 and/or receive information from the second processing unit 106.

In some examples, the term “communicatively coupled” may refer to a communication connection, which may be direct or indirect. A communication connection may be wired and/or wireless. A wired connection may refer to a conductive path, a trace, or a physical medium (excluding wireless physical mediums) over which information may travel. A conductive path may refer to any conductor of any length, such as a conductive pad, a conductive via, a conductive plane, a conductive trace, or any conductive medium. A direct communication connection may refer to a connection in which no intermediary component resides between the two communicatively coupled components. An indirect communication connection may refer to a connection in which at least one intermediary component resides between the two communicatively coupled components. In some examples, a communication connection may enable the communication of information (e.g., the output of information, the transmission of information, the reception of information, or the like). In some examples, the term “communicatively coupled” may refer to a temporary, intermittent, or permanent communication connection.

Any device or component described herein may be configured to operate in accordance with one or more communication protocols. For example, a first and second component may be communicatively coupled over a connection. The connection may be compliant or otherwise be in accordance with a communication protocol. As used herein, the term “communication protocol” may refer to any communication protocol, such as a communication protocol compliant with a communication standard or the like. As an example, a communication protocol may include the Display Serial Interface (DSI) protocol. DSI may enable communication between the third processing unit 108 and the display 103 over a connection, such as a bus.

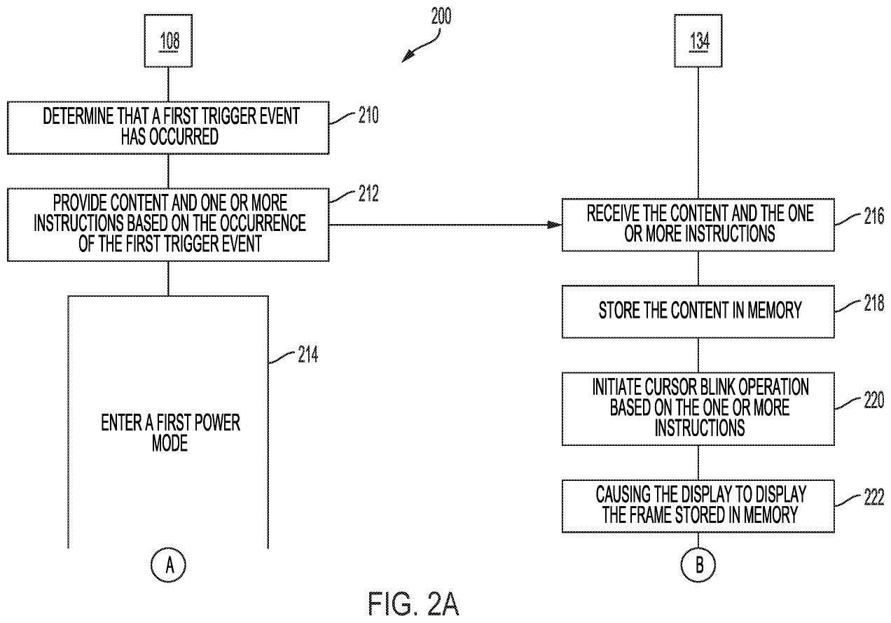

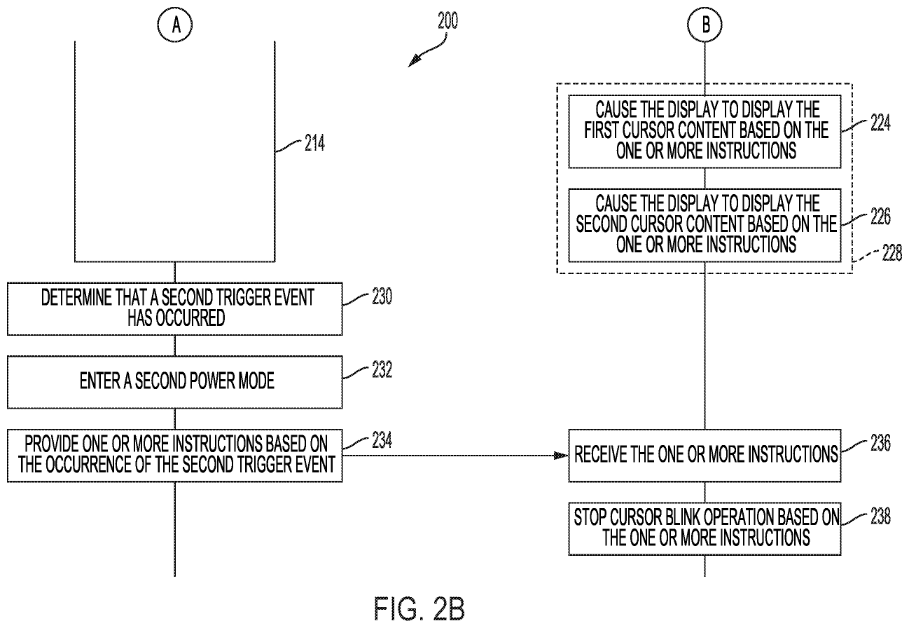

FIGS. 2A and 2B illustrate an example flow diagram 200 in accordance with the techniques described herein. In other examples, one or more techniques described herein may be added to the flow diagram 200 and/or one or more techniques depicted in the flow diagram may be removed. One or more blocks shown in FIGS. 2A and B may be performed in parallel.

In the example of FIGS. 2A and B, at block 210, the third processing unit 108 may be configured to determine that a first trigger event has occurred. The occurrence of the first trigger event could cause the blinking operation to be performed. For example, the first trigger event could be a duration of inactivity, where the device 100 (e.g., the first processing unit 104 of the device 100) does not receive input from the input device 113 and/or the display 103. In some examples, the first trigger event could be when the display driver registers for a timeout with at least one component of the display processing pipeline 112.

At block 212, the third processing unit 108 may be configured to provide content and one or more instructions based on the occurrence of the first trigger event to the processing unit 134 to cause the processing unit 134 to initiate the blinking operation corresponding to the application. The content that the third processing unit 108 provides to the processing unit 134 may be one or more frames (e.g., a single frame or a plurality of frames) of content, first cursor content (e.g., first cursor content that is representative of a first cursor state), and second cursor content (e.g., first cursor content that is representative of a second cursor state). In some examples, the one or more instructions sent to the processing unit 134 may be instructions to store (e.g. buffer) the one or more frames received from the third processing unit 108. At block 214, the third processing unit 108 may be configured to enter a first power mode. A power mode may refer to a power state in some examples. The third processing unit 108 may enter the first power mode at some point after the content and one or more instructions of block 212 have been provided to processing unit 134. The first power mode may be a low power/reduced power state where power consumption of the third processing unit 108 is lowered during the blinking operation. During the blinking operation, the processing unit 134 drives the display 103 by swapping out the first and second cursor content independent of the third processing unit 108. As such, the third processing unit 108 is not required to compose any frames and/or content to be displayed on the display during the blinking operation. As such, the third processing unit 108 can enter the reduced power state and provide a power saving feature for the device 100.

At block 216, the processing unit 134 may be configured to receive the content and the one or more instructions from the third processing unit 108. At block 218, the processing unit 134 may be configured store the received content in a plurality of memory regions (e.g., memory regions 136A-C). For example, the processing unit 134 may be configured to store a frame of content in a first memory region (e.g., the first memory region 136A), where the frame for display is stored/buffered in the first memory region 136A, the first cursor content is stored/buffered in a second memory region (e.g., the second memory region 136B), and the second cursor content is stored/buffered in a third memory region (e.g., the third memory region 136C). In some examples, the content stored on memory regions 136A-C may be a frame for display and cursor content. For example, the cursor content may be representative of a cursor that is to be displayed within the frame. The cursor content may include a first cursor content and a second cursor content. The first cursor content may be representative of the cursor in a visible state. The second cursor content may be representative of the cursor in a non-visible state.

At block 220, the processing unit 134 may be configured to initiate the cursor blink operation based on the one or more instructions. The third processing unit 108 may be configured to send instructions to the processing unit 134 to initiate the cursor blink operation. The processing unit 134 may be configured to initiate the cursor blink operation upon receipt of the instructions from the third processing unit 108. The cursor blink operation may be configured to update a portion of the frame for display, whereby the first cursor content and the second cursor content may be displayed within the frame. The portion of the frame may be referred to as a target region, specified region, dirty region, or the like. The processing unit 134 may be configured to copy the first cursor content from the second memory region 136B into a specified region in the first memory region 136A. The third processing unit 108 may be configured to define the location of the specified region within the first frame stored in the first memory region. The third processing unit provides the location of the specified region to the processing unit 134, such that the processing unit 134 knows the precise location as to where to copy the first and second cursor content into the first memory region 136A. The third processing unit 108 may be configured to define the period of time for which the first and second cursor content are to be displayed within the first frame. The third processing unit provides instructions to the processing unit 134 which defines the period of time and location that the first and second cursor content are to be displayed within the first frame. The first cursor content may be representative of the cursor in a visible or SHOW state. The second cursor content may be representative of the cursor in a non-visible or HIDE state. The SHOW and HIDE states of the cursor may each be displayed within the frame for a period of time in an alternating fashion to provide the appearance of blinking content (in this example, a blinking cursor) at the portion of the frame.

At block 222, the processing unit 134 causes the display 103 to display the frame stored in memory. The processing unit 134 obtains the generated content or frame from the first memory region 136A. For example, the processing unit 134 may be configured to obtain one or more frames of generated content from the first memory region 136A.

At block 224, the processing unit 134 may be configured to cause the display 103 to display the first cursor content based on the one or more instructions. The processing unit 134 may be configured to copy the first cursor content from the second memory region 136B into a specified region in the first memory region 136A. The copying of the first cursor content may occur at a first time, where the first time may correspond to an end of a first period in a cycle.

At block 226, the processing unit 134 may be configured to cause the display to display the second cursor content based on the one or more instructions. The processing unit 134 may be further configured to copy the second cursor content from the third memory region 136C into the specified region in the first memory region 136A. The copying of the second cursor content may occur at a second time, where the second time may correspond to an end of a second period in the cycle. After the second cursor content has been displayed within the specified region for the instructed period of time, the processing unit 134 may be configured to copy the first cursor content into the specified region in the first memory region to replace the second cursor content within the specified region. The swapping out of the first and second cursor content repeats and shows the first and second cursor content in alternating fashion, to represent a blinking cursor. The blinking operation continues until the processing unit 134 receives instructions/commands to stop.

In some examples, the first period and/or the second period may include one or more vertical sync (VSync) units in length, where a VSync unit may correspond to a period of time. In some examples, the first period and the second period may be the same. In some examples, the first period and the second period may be different. The third processing unit 108 may be configured to send instructions to the processing unit 134 which indicates the VSync units. In some examples, the VSync unit may be dependent upon the refresh rate of the display and/or the display duration of the first and/or second cursor content. In some examples, the refresh rate of the display 103 may be 60 FPS (frames per second), which results in the display needing to be refreshed every 16.67 ms. In some examples, the blinking operation may be configured to display the first and/or second cursor content for a duration of 500 ms. As such, the VSync unit equals the display duration of the first and/or second cursor content divided by the refresh time of the display 103 (e.g., 500 ms/16.67 ms) which equals 30VSync units. In some examples, the first and second cursor content can be displayed for the same number of VSync units. In some examples, the first and/or second cursor content can be displayed for different number of VSync units.

The processing unit 134 may be configured to receive instructions from the third processing unit 108 that identifies the specified region in the first memory region 136A. The instructions with regards to the VSync units and identification of the specified region from the third processing unit 108 enables the processing unit 134 to know the timing in which the first and second cursor content are to be displayed within the frame and the proper location of the specified region in which the first and second cursor content are to be copied within the first memory region. Such instructions assists the processing unit 134 to properly perform the blinking operation. For example, the first cursor content is copied to the proper location for the set duration, and is swapped out with the second cursor content, such that the second cursor content is subsequently copied to the proper location for the set duration. The second cursor content is then swapped out with the first cursor content and the cycle may repeat until the blinking operation is terminated. The first cursor content and second cursor content swap for the set duration until the blinking operation is instructed to stop. The first cursor content and the second cursor content repeatedly update the specified region of the frame, and display the cursor in a blinking arrangement within the specified region of the frame. Block 228 is representative of the cyclical repeating process of the first and second cursor content.

At block 230, the third processing unit determines that a second trigger event has occurred. In some examples, a second trigger event could occur which may cause the blinking operation to stop. For example, the second trigger event could be receipt of an input from the input device 113 and/or the display while the blinking operation is being performed. At block 232, the third processing unit may be configured to enter a second power mode. The second power mode can represent the third processing unit being in a full power mode or an active state, such that the third processing unit has awaken from the inactive state or low power mode and may be configured to be fully operational. With reference back to block 214, the instructions from the third processing unit 108, represented by block 212, allow the processing unit 134 to operate independently during the blinking operation such that at least the third processing unit 108 may be arranged to enter into the first power mode. The first power mode may also be an inactive state, where the third processing unit 108 is in an inactive state and in a reduced or low power mode. The third processing unit 108 being in the inactive state or first power mode allows the third processing unit to be in a low power state, due to the processing unit 134 being able to perform the blinking operation without constant instructions or involvement from the third processing unit 108. The third processing unit 108 may remain in the low power state or first power mode throughout the duration of the blinking operation, which in turn reduces power usage. The third processing unit 108 may be configured to remain in the first power mode until the third processing unit detects the occurrence of the second trigger event. At block 232, the third processing unit 108 enters a second state or second power mode. The third processing unit 108 enters the second state or second power mode from the first state or first power mode.

At block 234, the third processing unit 108 may be configured to provide one or more instructions to the processing unit 134 based on the occurrence of the second trigger event. At block 236, the processing unit 134 receives the one or more instructions from the third processing unit 108. In some examples, the one or more instructions received by the processing unit 134 at block 236 can be instructions to stop the cursor blinking operation. The cursor blinking operation stops due to the second trigger event, which in some examples, can be input from the input device 113 or display 103 received by the third processing unit 108. In some examples, the input from the input device 113 or display 103 may be received by any component of the display processing pipeline, such as, the first processing unit 104, the second processing unit 106, and/or the third processing unit 108.

At block 238, the processing unit 134 may be configured to stop the cursor blink operation based on the one or more instructions received from the third processing unit 108. The cursor blink operation may be configured to stop during any portion of the cycle represented by block 228. In some examples, the cursor blink operation may be configured to stop at the end of the period of time that either the first and/or second cursor content is being displayed. In some examples, the blinking operation may be configured to interrupt the period of time that either the first and/or second cursor content is being displayed.

While blocks 224, 226, and 228 are shown relative to the other blocks in FIGS. 2A and B, it is understood that blocks 224, 226, and 228 may occur in parallel with the other blocks shown in FIGS. 2A and B. In some examples, blocks 224, 226, and 228 may be referred to as a display feature configuration routine.

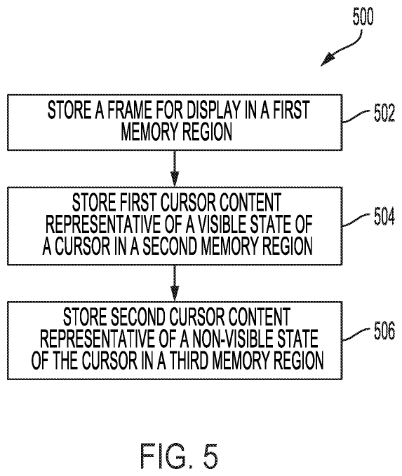

FIG. 5 illustrates an example flowchart 500 of an example method in accordance with one or more techniques of this disclosure. The method may be performed by one or more components of a first apparatus. The first apparatus may, in some examples, be the device 100. In some examples, the method illustrated in flowchart 500 may include one or more functions described herein that are not illustrated in FIG. 5, and/or may exclude one or more illustrated functions.

At block 502, a first processing unit may be configured to store a frame for display in a first memory region of a plurality of memory region accessible to the first processing unit. In some examples, the first processing unit may be the third processing unit 108, and the first memory region may be the first memory region 136A. At block 504, the first processing unit may be configured to store first cursor content in a second memory region of the plurality of memory regions accessible to the first processing unit. In some examples, the first cursor content may be representative of a visible state of a cursor, and the second memory region may be the second memory region 136B. At block 506, the first processing unit may be configured to store second cursor content in a third memory region of the plurality of memory region accessible to the first processing unit. In some examples, the second cursor content may be representative of a non-visible state of the cursor, and the third memory region may be the third memory region 136C.

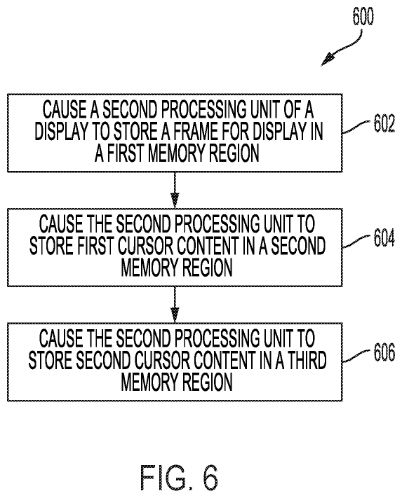

FIG. 6 illustrates an example flowchart 600 of an example method in accordance with one or more techniques of this disclosure. The method may be performed by one or more components of a first apparatus. The first apparatus may, in some examples, be the device 100. In some examples, the method illustrated in flowchart 600 may include one or more functions described herein that are not illustrated in FIG. 6, and/or may exclude one or more illustrated functions.

At block 602, a first processing unit may be configured to cause a second processing unit of a display to store a frame for display in a first memory region. In some examples, the first processing unit may be the third processing unit 108, and the second processing unit may be the processing unit 134. At block 604, the first processing unit may be configured to cause the second processing unit to store first cursor content in a second memory region. In some examples, the first cursor content may be representative of a visible state of a cursor. At block 606, the first processing unit may be configured to cause the second processing unit to store second cursor content in a third memory region. In some examples, the second cursor content may be representative of a non-visible state of the cursor. In some examples, the first memory region may be the first memory region 136A, the second memory region may be the second memory region 136B, and the third memory region may be the third memory region 136C.

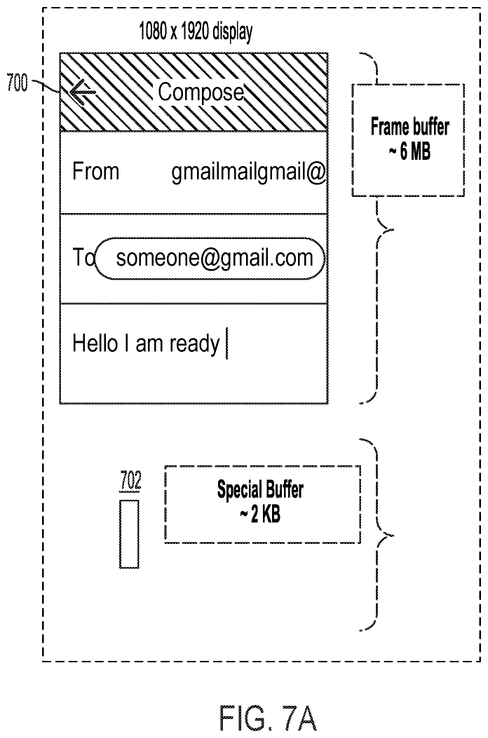

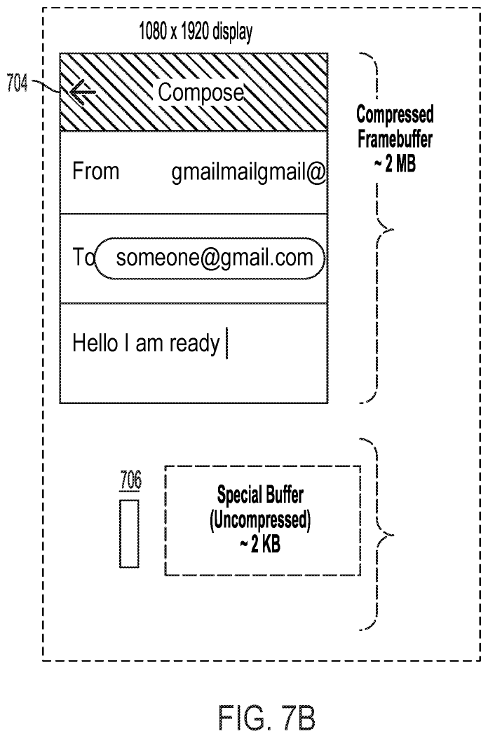

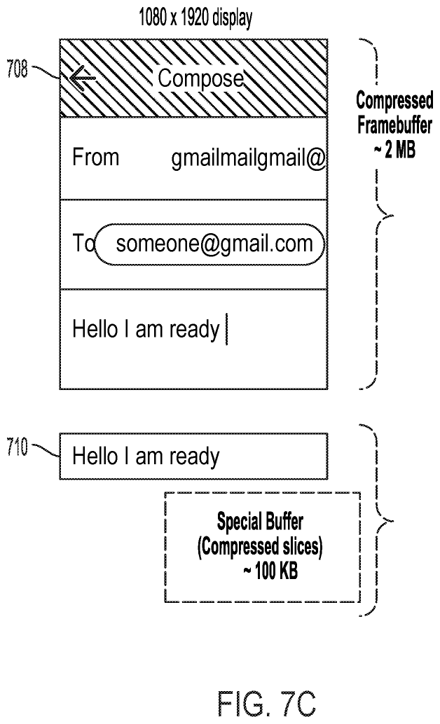

FIG. 7A illustrates another example of a content blink operation in accordance with the techniques described herein. A frame buffer content 700 may be displayed, for example, on a 1080×1920 display panel. In this example, the frame buffer may be approximately 6 MB in size. As illustrated, the frame buffer content 700 display a cursor in a visible state. An auxiliary buffer 702 may store content representative of the cursor in an invisible state. In this example, the auxiliary buffer may be approximately 2 KB, as it only needs to store a display region with the cursor in the invisible state. An alternative embodiment may be where the frame buffer content 700 includes the cursor in an invisible state, while the auxiliary buffer 702 stores content representative of the cursor in a visible state.

This example is an improvement over a prior approach, which required two buffers in a ping-pong arrangement, a first buffer storing the cursor in a visible state and a second buffer storing the cursor in an invisible state. For example, this may reduce required memory, as only one auxiliary buffer is used, instead of two buffers in the ping-pong arrangement. A partial update can be used to cycle between the cursor's visible and invisible states at a specific frequency or period, causing a blinking cursor effect in a user interface.

It will be appreciated that a command mode panel may be enhanced with memory to store a typical cursor size, for example, 2 KB in this example with a 1080p display panel. A new DSI command may be defined to send a partial update command along with region coordinates or a display location, which will be used by a panel controller to superpose content from auxiliary buffer onto framebuffer while refreshing display. The region coordinates may be display coordinates indicative of the display location of the cursor location as discussed. The coordinates may be associated with the cursor by the host processor. The cursor content is then transferred into auxiliary buffer. A period or frequency is computed to as a number of VSync units, when the display processor will switch between the displaying the frame buffer and superposing the auxiliary buffer. Determining the VSync units can occur at the host processor, display processor, or another processing unit. It will be appreciated that two periods can be computed: a first period for how long the cursor remains in the visible state, or a first visibility state, and a second period for how long the cursor remains in the invisible state, or a second visibility state.

The display panel controller will begin VSync counting upon receiving the partial update command from the host processor. The auxiliary buffer content is superposed into frame buffer in the specified region or display location after the specified number VSync units have elapsed while refreshing the display. Thus, responsive to the count elapsing, a next operation may be executed. The frame buffer is refreshed onto the display panel after the specified number of VSync units have elapsed. This terminates the superposing of the auxiliary buffer. Terminating the superposing of the auxiliary buffer reverts the display back to the frame buffer contents. This may continue until a new update from the host processor is received. For example, the host processor may interrupt or terminate the blinking cursor cycle when new user input is received.

It will be appreciated that the host processor may detect a blinking cursor cycle, for example, after a period of no user inputs or activity. A framework or a display software may be notified, along with application buffer holding state data. The host processor may compose and transfer the information above, along with the computed period or periods. As the blinking cursor cycle has been initiated at the display panel, the host processor may put the display hardware in power collapse mode and the DSI in ULPS (ultra-low power state) mode. Triggering such power saving modes will save power. The host processor may further enter a power-savings mode if appropriate. Responsive to user input, the host processor may wake. Upon waking, the host processor may resume requested or ordinary user interface.

FIG. 7B illustrates another example of a content blink operation in accordance with the techniques described herein. A DSC compressed frame buffer content 704 may be displayed, for example, on a 1080×1920 display panel. In this example, the frame buffer may be approximately 2 MB. As illustrated, the frame buffer content 704 display a cursor in a visible state. A auxiliary buffer 706 may store uncompressed content representative of the cursor in an invisible state. In this example, the auxiliary buffer may be approximately 2 KB, as it only needs to store a display region with the cursor in the invisible state, similar to the example above. An alternative embodiment may be where the DSC compressed frame buffer content 704 includes the cursor in an invisible state, while the auxiliary buffer 706 storing uncompressed content representative of the cursor in a visible state.

This example supports DSC compressed frame buffer content with an uncompressed auxiliary buffer. Cursor region pixels are transferred from the frame buffer to the auxiliary buffer. A second cursor state is transferred to the panel memory from the host processor, and the auxiliary buffer is superposed at a given frequency over the frame buffer to provide the blinking cursor effect. In contrast to the example above, the cursor in the second state is decompressed from the frame buffer before storing in the auxiliary buffer. This prevents aliasing in the blinking cursor region on the display panel due to DSC compression.

A DSC command is added to instruct the display or panel processor to uncompress at least a portion of the frame buffer containing the cursor and copy the uncompressed pixels into the auxiliary buffer. A timer, period, or frequency will be set by the host processor. The timer may expire a few VSyncs before the cursor starts a blink cursor cycle, for example, 470 ms if cursor blinks after 500 ms. The host processor may guarantee there is at least one display refresh cycle (>16 ms time) before the frame buffer is replaced with next cursor state from the host. The host processor may instruct the panel or display processor to copy pixels into auxiliary buffer. This allows a ‘Cursor SHOW’ functionality, where pixels are copied into auxiliary buffer. On receiving a blink hint from a framework, the host processor may compose and transfer ‘Cursor HIDE’ frame buffer slices to the frame buffer. The host processor will then send a period, for example, denominated in VSync units, for ‘Switch to auxiliary buffer’ and ‘Switch to framebuffer’. The display processor or controller superposes pixels from the auxiliary buffer while refreshing display after specified ‘Switch to auxiliary buffer’ VSync units.

It will be appreciated the auxiliary buffer is superposed on to or over the frame buffer as displayed. For example, while refreshing a display or content into the auxiliary buffer is transferred from the frame buffer when decoding for a display refresh.

FIG. 7C illustrates another example of a content blink operation in accordance with the techniques described herein. A DSC compressed frame buffer content 708 may be displayed, for example, on a 1080×1920 display panel. In this example, the frame buffer may be approximately 2 MB in size. As illustrated, the frame buffer content 708 display a cursor in a visible state. A auxiliary buffer 710 may store one or more compressed frame slices, including a display region including the cursor in an invisible state. In this example, the auxiliary buffer may be approximately 100 KB, as it stores one or more compressed frame buffer slices.

This example proposes a partial update by adding panel memory as an auxiliary buffer to be used by the host processor to store DSC slices or a complete compressed slice containing a cursor off (or on) visibility state. The host processor may then request a display panel controller to use slices from auxiliary buffer at a given frequency to effect the blinking cursor effect. In contrast to the above examples, the auxiliary buffer must be larger to store compressed DSC slices containing lines that include the cursor.

Thus, the auxiliary buffer may store approximately 6 DSC slices in a 1080p display which approximates to ˜100 KB extra memory. Upon receiving a blink hint from a framework, the host processor may compose, encode and transfer slices where the cursor is present into the auxiliary buffer. The host processor may send VSync units for ‘Switch to auxiliary buffer’ and ‘Switch to framebuffer’ as discussed above. The display controller may be configured to ignore frame buffer slices in the specified region and instead use slices from auxiliary buffer to refresh the display after specified ‘Switch to auxiliary buffer’ VSync units. The auxiliary buffer may be superposed into or over the frame buffer when refreshing the display panel.

In another example embodiment, it will be appreciated that one or more additional auxiliary buffers may be added to the implementations discussed above. In one example, each auxiliary buffer may store one or more screen content element on the same blink cycle i.e. elements will blink contemporaneously. It will be appreciated a second auxiliary buffer may store one or more screen content element, wherein the elements of the second auxiliary buffer are on a different blink cycle than the first auxiliary buffer. Similarly, additional auxiliary buffers may store screen content elements on a blink cycle different from the cycles above.

It will be appreciated that in an example configuration as discussed herein, an average current reduction of ˜20 mA may be achieved at a battery level. At least the host processor, display processor, and DSI PLL, among other components may enter and remain in power saving or power collapsed mode for the duration of cursor blinking. Example applications utilizing a blinking cursor effect include, but are not limited to: Messaging applications such as WhatsApp, Snapchat, VChat, Hangout, SMS etc., Email applications such as: Gmail, Outlook, Yahoo, Mymail etc., Productivity applications, browsers, and other applications utilizing a user input/output interface.

In accordance with this disclosure, the term “or” may be interrupted as “and/or” where context does not dictate otherwise. Additionally, while phrases such as “one or more” or “at least one” or the like may have been used for some features disclosed herein but not others; the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, it is understood that such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules or units are described in this disclosure to emphasize functional aspects of devices configured to perform the disclosed techniques, but do not necessarily require realization by different hardware units. Rather, as described above, various units may be combined in any hardware unit or provided by a collection of interoperative hardware units, including one or more processors as described above, in conjunction with suitable software and/or firmware.

Various examples have been described. These and other examples are within the scope of the following claims.

What is claimed is:

1. An apparatus for displaying content, the apparatus comprising:
a panel memory;
a first auxiliary buffer;
a host processor, the host processor configured to,
store a frame for display in the panel memory, wherein the frame includes a first element at a first display location in a first visibility state, and
store a content representative of the first element in a second visibility state in the first auxiliary buffer and associated display coordinates indicative of the first display location; and
a display processor, the display processor configured to,
display the frame for display,
responsive to a first period elapsing, superpose the content representative of the first element in the second visibility state at the first display location, and
responsive to a second period elapsing, terminate superposing of the content representative of the first element in the second visibility state.

2. The apparatus of claim 1, wherein the frame for display is stored compressed in the panel memory, and the content representative of the first element in the second visibility state is stored uncompressed in the first auxiliary buffer.

3. The apparatus of claim 1, wherein the frame for display is stored compressed in the panel memory, and the content representative of the first element in the second visibility state includes a complete compressed slice of the frame.

4. The apparatus of claim 1, further comprising:
a second auxiliary buffer, wherein the host processor is further configured to,
store a content representative of a second element in a second visibility state in the second auxiliary buffer and associated display coordinates indicative of a second display location, wherein the frame includes the second element at the second display location in a first visibility state, and wherein the display processor is further configured to,
responsive to a third period elapsing, superpose the content representative of the second element in the second visibility state at the second display location, and
responsive to a fourth period elapsing, terminating superpose of the content representative of the second element in the second visibility state.

5. The apparatus of claim 1, wherein the host processor is further configured to trigger a power-saving mode.

6. The apparatus of claim 5, wherein the host processor is further configured to wake from the power-saving mode responsive to user input terminating a blink cycle.

7. The apparatus of claim 1, wherein the first visibility state of the first element is visible, and the second visibility state of the first element is invisible.

8. The apparatus of claim 1, wherein the host processor is further configured to determine the first and second periods to each be one or more vertical sync (VSync) units in length.

9. A method for displaying content, the method comprising:
storing, by a host processor, a frame for display in a panel memory, wherein the frame includes a first element at a first display location in a first visibility state;
storing, by the host processor, a content representative of the first element in a second visibility state in a first auxiliary buffer and associated display coordinates indicative of the first display location;
displaying, by a display processor, the frame for display;
superposing, by the display processor responsive to a first period elapsing, the content representative of the first element in the second visibility state at the first display location; and
responsive to a second period elapsing, the display processor terminating superposing of the content representative of the first element in the second visibility state.

10. The method of claim 9, wherein the frame for display is stored compressed in the panel memory, and the content representative of the first element in the second visibility state is stored uncompressed in the first auxiliary buffer.

11. The method of claim 9, wherein the frame for display is stored compressed in the panel memory, and the content representative of the first element in the second visibility state includes a complete compressed slice of the frame.

12. The method of claim 9, further comprising:
storing, by the host processor, a content representative of a second element in a second visibility state in a second auxiliary buffer and associated display coordinates indicative of a second display location, wherein the frame includes the second element at the second display location in a first visibility state,
superposing, by the display processor responsive to a third period elapsing, the content representative of the second element in the second visibility state at the second display location; and
responsive to a fourth period elapsing, the display processor terminating superposing of the content representative of the second element in the second visibility state.

13. The method of claim 12, further comprising:
triggering a power-saving mode by the host processor.

14. The method of claim 9, further comprising:
responsive to user input terminating a blink cycle, waking the host processor from the power-saving mode.

15. The method of claim 9, wherein the first visibility state of the first element is visible, and the second visibility state of the first element is invisible.

16. The method of claim 9, further comprising:
determining the first and second periods to each be one or more vertical sync (VSync) units in length.

17. An apparatus for displaying content, the apparatus comprising:
a means for storing a frame for display;
a means for storing content of a first element;
a means for host processing configured to,
store a frame for display in the means for storing a frame for display, wherein the frame includes a first element at a first display location in a first visibility state, and
store a content representative of the first element in a second visibility state in the means for storing content of a first element and associated display coordinates indicative of the first display location; and
a means for display processing configured to,
display the frame for display,
responsive to a first period elapsing, superpose the content representative of the first element in the second visibility state at the first display location, and
responsive to a second period elapsing, terminate superposing of the content representative of the first element in the second visibility state.

18. The apparatus of claim 17, wherein the frame for display is stored compressed in the means for storing a frame for display, and the content representative of the first element in the second visibility state is stored uncompressed in the means for storing content of a first element.

19. The apparatus of claim 17, wherein the frame for display is stored compressed in the means for storing a frame for display, and the content representative of the first element in the second visibility state includes a complete compressed slice of the frame.

20. The apparatus of claim 17, further comprising:
a means for storing content of a second element, wherein the means for host processing is further configured to,
store a content representative of a second element in a second visibility state in the means for storing content of a second element and associated display coordinates indicative of a second display location, wherein the frame includes the second element at the second display location in a first visibility state, and wherein
the means for display processing is further configured to,
responsive to a third period elapsing, superpose the content representative of the second element in the second visibility state at the second display location, and
responsive to a fourth period elapsing, terminating superpose of the content representative of the second element in the second visibility state.

21. The apparatus of claim 17, wherein the means for host processing is further configured to trigger a power-saving mode.

22. The apparatus of claim 21, wherein the means for host processing is further configured to wake from the power-saving mode responsive to user input terminating a blink cycle.

23. The apparatus of claim 17, wherein the first visibility state of the first element is visible, and the second visibility state of the first element is invisible.

24. The apparatus of claim 17, wherein the means for host processing is further configured to determine the first and second periods to each be one or more vertical sync (VSync) units in length.

25. A non-transitory computer-readable storage medium having stored thereon instructions that, when executed, cause a processor to execute a method for displaying content, the method comprising:
storing, by a host processor, a frame for display in a panel memory, wherein the frame includes a first element at a first display location in a first visibility state;
storing, by the host processor, a content representative of the first element in a second visibility state in a first auxiliary buffer and associated display coordinates indicative of the first display location;
displaying, by a display processor, the frame for display;
superposing, by the display processor responsive to a first period elapsing, the content representative of the first element in the second visibility state at the first display location; and
responsive to a second period elapsing, the display processor terminating superposing of the content representative of the first element in the second visibility state.

26. The medium of claim 25, wherein the frame for display is stored compressed in the panel memory, and the content representative of the first element in the second visibility state is stored uncompressed in the first auxiliary buffer.

27. The medium of claim 25, wherein the frame for display is stored compressed in the panel memory, and the content representative of the first element in the second visibility state includes a complete compressed slice of the frame.

28. The medium of claim 25, the method further comprising:
storing, by the host processor, a content representative of a second element in a second visibility state in a second auxiliary buffer and associated display coordinates indicative of a second display location, wherein the frame includes the second element at the second display location in a first visibility state,
superposing, by the display processor responsive to a third period elapsing, the content representative of the second element in the second visibility state at the second display location; and
responsive to a fourth period elapsing, the display processor terminating superposing of the content representative of the second element in the second visibility state.

29. The medium of claim 25, the method further comprising:
triggering a power-saving mode by the host processor;
responsive to user input terminating a blink cycle, waking the host processor from the power-saving mode; and
determining the first and second periods to each be one or more vertical sync (VSync) units in length.

30. The medium of claim 25, wherein the first visibility state of the first element is visible, and the second visibility state of the first element is invisible.
